(19) United States
(12) Patent Application Publication
(10) Pub. No.: US 2009/0315752 A1
(43) Pub. Date: Dec. 24, 2009

(54) METHOD, APPARATUS AND PROGRAM PRODUCT FOR AUTOMATICALLY TURNING ON OR OFF MULTIPLE DEVICES WITH A REMOTE CONTROL

(75) Inventors: Judith Helen Bank, Morrisville, NC (US); Dimple Bhatia, San Jose, CA (US); Lisa Marie Wood Bradley, Cary, NC (US); Dana Lea Price, Cary, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/144,033

(22) Filed: Jun. 23, 2008

(51) Int. Cl. H04L 17/02

(52) U.S. Cl. 341/176

(57) ABSTRACT

A programmable universal remote controller is programmed with adjustable inactivity period timeout and control capabilities whereby each individual external controlled device's activity status may be monitored and the device automatically turned on or off by the remote controller when the remote controller detects that the device has been inactive for a desired period of time based on the history of the remote controller's interaction with the controlled device.

### FIELD OF THE INVENTION

The invention relates generally to remote control units and more specifically to remote control units that control a plurality of devices.

### BACKGROUND

So-called “universal” remote control units have gained widespread popularity for use in the home to control a variety of electronic devices such as television sets, cable boxes or converters, satellite receiver boxes, stereo systems, ceiling fans, floor fans, video recorders of both the cassette and digital variety, digital video disc players and many, many more devices such as ovens, irons, monitors, lights, heating, ventilating, air conditioning, security, cooking, alarms and an ever-growing list of devices employed in digitally controlled home environments, etc. The universality of the remote control units such as that shown in U.S. Pat. Nos. 7,324,168 or 7,224,903 is due to their programmability for controlling a plurality of devices as shown in the first-mentioned patent and to their ability to be automatically programmed by acquiring control data from any particular controlled device at which the remote controller is pointed as shown in the later mentioned patent.

However, one significant drawback with the plethora of devices that may be controlled with a universal controller and with the functionality of the known remote controllers for them is that some or all of the controlled devices may inadvertently be left on, thus consuming power and aging the electronic components unnecessarily, creating undesirable noise or raising fire hazards or other security and safety issues. Some universal remote control devices do have a “universal on-off” function whereby all of the controlled devices may be simultaneously turned on or off, but this characteristic requires specific manual action on the part of the user and is not altogether desired when a user wishes to continue to use one or more of the controlled devices while others are turned off.

The present invention solves the aforementioned problems by providing a programmable universal remote controller that may be programmed with adjustable inactivity period timeout and turnoff capabilities whereby each individual controlled device's activity status may be monitored and the device automatically turned off by the remote controller when the remote controller detects that the device has been inactive for a desired period of time based on the history of the remote controller's interaction with the controlled device. If a user has not used the remote control to control a device in a user-specified period of time, it may be assumed that the user is no longer using the device controlled by the controller. In this way, the user need not remember to turn off the controlled devices. The remote controller will detect any controlled device that has not been activated or controlled in some way or used by the user for a programmably defined period of time and then will automatically issue the correct turn off signal to turn off the inactive device.

### SUMMARY

The present invention provides an enhanced method, program and apparatus for a so-called universal remote controller. The enhanced remote controller of this invention has either or both preprogrammed inactivity periods or user-determined programmed inactivity periods which are monitored by the enhanced remote controller which issues a turn off signal to any monitored device whose inactivity period has been reached, thus automatically turning off controlled devices that are no longer in active use.

The enhanced remote controller of the invention may also have a function of re-setting elapsed inactivity times to zero for each given device whenever the user interacts via the remote controller with that controlled device because any such user interaction with the device is assumed to be indicative that the user is still using the device and does not desire to have it automatically turned off. The universal remote controller of this invention thus monitors the activity status of each controlled device and issues individual turn off signals via the usual transmitter in the remote controller to the devices whose prescribed inactivity period has been reached. This saves the user's attention for other activities while also conserving power and reducing ageing of electronic components, reducing fire and other security hazards and eliminating the need to pre-program automatic turnoff features that may be present in the controlled devices themselves.

### BRIEF DESCRIPTION OF THE DRAWINGS

The foregoing and other objects and advantages of the invention will be appreciated more fully from the following further description thereof with reference to the accompanying drawings, wherein:

FIG. 1 illustrates schematically the block diagram of a preferred method of the invention as embodied in a program in universal remote controller for monitoring the activity status of each device controlled by the controller by observing the user's interaction with the device via the remote controller.

FIG. 2 is a depiction of a feature of the preferred method and program of the invention for resetting the inactivity count or elapsed times to zero whenever the user interacts with a given controlled device.

FIG. 3 is an overall view of a known prior art universal controller having internally a processor capable of executing programs, memory useable by said processor, and a transmitter of either or both infra-red or radio frequency control types, which may be programmed via data entry or by programs stored in memory to embody, together with the remote controller, the enhancements of the invention.

FIG. 4 is an internal block diagram of the major components of a known prior art universal controller as shown in FIG. 3 and illustrating the elements used by the present invention for entering user defined inactivity periods into the memory via the processor where the methods and programs of FIG. 1 and FIG. 2 of this invention may be conveniently stored for execution in carrying out the method herein.

### DETAILED DESCRIPTION

The invention will now be described in detail with reference to a preferred embodiment thereof as illustrated in the Drawings mentioned above.

The invention provides a universal remote controller apparatus and method for automatically turning off individual devices controlled by the controller whenever prescribed periods of inactivity are observed by the universal controller for such device.

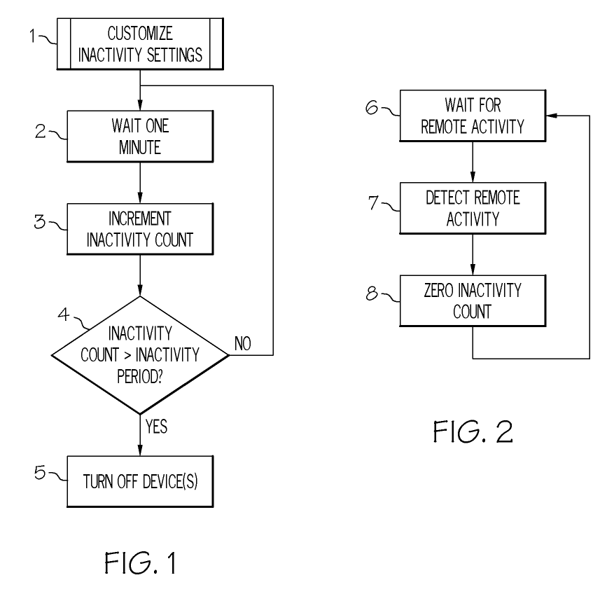

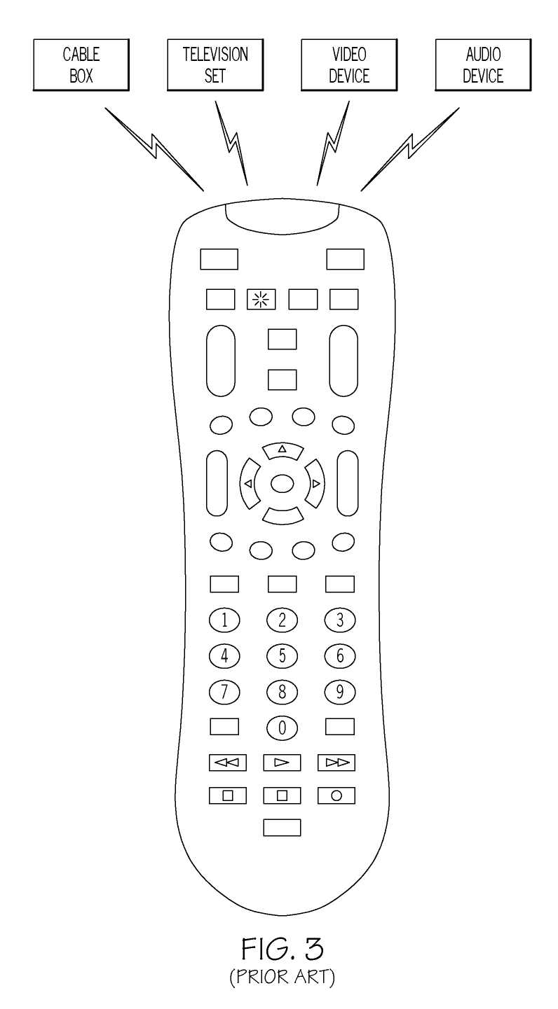

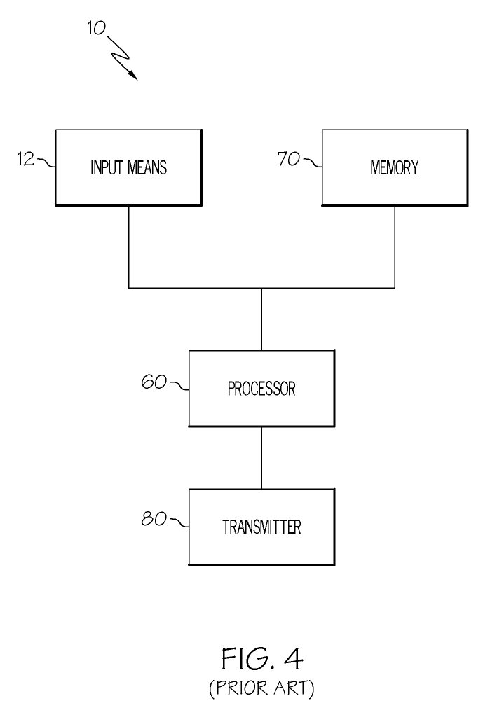

Turning to FIG. 1, a block diagram illustration of the method or process of the invention is shown as a logical flow schematic. In FIG. 1, the method of the present invention is illustrated as a logical diagram of the steps implemented in suitable code in a processor in a universal remote controller of the sort know in the prior art and depicted in FIGS. 3 and 4. The method of the invention as shown in FIG. 1 begins in box 1 with the user entering data via the data entry means such as a keypad as shown in FIG. 3 in a prior art controller. The user's data is in the form of desired inactivity period to be found by the method when executed in the processor for a given controlled device for which the user enters his desired period of inactivity to be observed by the processor before issuing the turn off command to the device in question.

The process is then depicted in box 2 to enter a one minute (or any other preferred time) increment to begin accumulating the user's desired inactivity period until turnoff for the chosen controlled device.

In box 3, the process increments an inactivity time count for the device whose inactivity time period is being monitored. Then, on box 4, the method compares the present inactivity count with the desired inactivity time period to determine whether the inactivity period has been fulfilled for the device in question and, if the answer is “no”, the process loops back to wait one minute and increment the inactivity count once more and the process repeats until the comparison in box 4 finds that the inactivity period has been fulfilled without any intervening control actions being taken by the remote controller and it causes the processor, as shown in the method box 5, to issue via a transmitter of the usual sort the turnoff code appropriate to the device whose inactivity has been monitored by the remote controller.

Continuing with FIG. 2, an essential part of the method of the invention is a further process in which the processor in the remote controller monitors for any interactions directed by the user via the remote controller with the device whose inactivity is being monitored by the processor via the method shown in FIG. 1. This is shown in boxes 6 and 7 in FIG. 2. If any control interactions are detected as shown in box 7, the inactivity period count being maintained by the processor is reset to zero as shown in box 8 since the device is obviously still in use by the user.

Since there may be numerous devices controlled by the universal remote controller of this invention, each individual device will have its own inactivity period to be observed until automatic turnoff is to be performed by the remote controller. For example, if the user is watching television, he or she may have entered a typical television watching cycle of 30 minutes as the inactivity period because a typical user will often perform such actions as changing the volume, switching channels, etc. during a viewing session. If the user should leave the room, fall asleep or simply let the program being viewed come to an end without interacting with the television via the remote controller, the inactivity period will be reached and the processor in the remote controller will automatically issue the turnoff command code signals via the transmitter of the remote controller.

Or the inactivity period for a television could be set for a few hours, assuming that the user with, within that period of time have some interaction with the television and this time period may be stored in the memory of the processor in the remote controller as a default value in case the user does not bother to enter any customized inactivity period for the television. Alternatively, as a default, the remote controller could be programmed in memory to turn off the television whenever a DVR (Digital Video Recorder) is turned off or when such a device's inactivity period is reached. Inactivity periods for a DVD player (Digital Video Disc player) might be chosen by the user to be in the range of several hours as that is the duration of a typical movie recorded on DVD's.

As can be appreciated from the foregoing brief description of the invention, numerous complex interactions with a wide variety of controlled devices can be envisioned in which the remote controller of the invention can be effectively employed to save the user many problems with devices inadvertently left on. For example, heating devices might pose a fire hazard if not turned off or fans or other electrical appliances may waste electrical power by being left on when no one is around to utilize them, etc.

Conversely, the user may well desire to utilize the inactivity period count to activate a controlled device instead of turning it off. For example, if a heating or ventilating or air conditioning system has not been operated for some prescribed time, it may be desirable to turn such system on and, perhaps, invoke a later turnoff via the controlled unit's built-in timer turn off function. Either on or off functions, therefore, may be envisioned as within the scope of this invention, although the description above employs the turn off function alone for simplicity in explanation.

Advantages of this invention may include that devices controlled by the universal remote controller will not be left on indefinitely when they are not actually being used, the user does not need to explicitly set any turnoff time that may be incorporated in any controlled devices, the device will not be turned off if it is still in active use and the device itself need not be modified in any way so long as it is enabled to be controlled by a universal remote controller of the sort described herein.

Wherefore, in view of the wide variety of remotely controllable devices available today and in view of the likelihood that many more home appliances, systems and devices will be offered in the future, a programmable universal remote controller which automatically turns off inactive devices will be a highly useful device in its own right, and may well be carried about the house by a user to interact with a variety of devices.

Furthermore, it is commonplace to have a universal remote controller for satellite receivers that uses both infra-red and radio frequency control transmissions to control the receivers in a household, but as line of sight and/or range of radio may be limited, intermediate receivers and re-transmitters are available for household use that will pick up signals from the universal remote controller and re-transmit them within other rooms or areas to control devices that are not in the immediate area of the user. Thus, a universal remote controller in the household so equipped with intermediate receiver-transmitters, (or even receiver, translator, transmitters where the intermediate receiver receives, say, radio frequency signals and re broadcasts in infra-red, or vice versa, or both) may be envisioned as an extension of the utility of the present invention to areas of household system control, such as those currently being marketed as the computer-controlled household security, lighting, heating, ventilation, air conditioning, cooking and other myriads of devices in use today.

Therefore, what is desired to be protected by letters patent is described in the claims which follow by way of general description and not by way of limitation.

What is claimed is:

1. An enhanced universal remote controller having the usual processor, data entry, memory and transmitter means and further comprising:
counting means maintaining a time period count;
comparison means for comparing said time period count with a desired value; and
signal issuing means responsive to said comparison means for controlling an external controlled device.

2. The enhanced universal remote controller of claim 1, further comprising:
detecting means for detecting any interactions of said universal remote controller with said external device; and
resetting means responsive to said detecting means for resetting said counting means to zero whenever any interactions occur between said universal remote controller and said external controlled device.

3. The enhanced universal remote controller of claim 1, further comprising means responsive to said comparison means for incrementing said time period count whenever the result of said comparison is not equal to said desired value.

4. The enhanced universal remote controller of claim 2, further comprising means responsive to said comparison means for incrementing said time period count whenever the result of said comparison is not equal to said desired value.

5. The enhanced universal remote controller of claim 1, wherein the processor of said universal remote controller maintains separate said desired values and separate time period counts for each of a plurality of said external controlled devices.

6. The enhanced universal remote controller of claim 5, wherein said signal issued by said signal issuing means turns said external device on or off.

7. In a universal remote controller having a processor, data entry, memory and transmitter means, an enhanced method of controlling external controlled devices comprising steps in said processor for:
incrementing a time period count;
comparing said time period count with a desired value; and
issuing responsive to said comparison means a signal for controlling an external controlled device.

8. The method of claim 7, further comprising steps for:
detecting interactions of said universal remote controller with said external device; and
resetting said time period count to zero whenever interactions are detected between said universal remote controller and said external controlled device.

9. The method of claim 7, further comprising steps for incrementing said time period count whenever the result of said comparing step is not equal to said desired value.

10. The method of claim 7, further comprising steps for incrementing said time period count whenever the result of said comparing step is not equal to said desired value.

11. The method of claim 7, wherein said issuing step further comprises transmitting said signal to said external controlled device.

12. A program product comprising a machine-readable media on which are recorded computer executable steps for:
incrementing a time period count;
comparing said time period count with a desired value; and
issuing responsive to said comparison means a signal for controlling an external controlled device.

13. A program product as described in claim 12, further comprising computer executable steps for:
detecting any interactions of said universal remote controller with said external device; and
resetting said time period count to zero whenever any interactions are detected between said
universal remote controller and said external controlled device.

14. A program product as described in claim 12, further comprising computer executable steps for incrementing said time period count whenever the result of said comparing step is not equal to said desired value.

15. The program product as described in claim 13, further comprising computer executable steps for incrementing said time period count whenever the result of said comparing step is not equal to said desired value.

16. The program product as described in claim 12, further comprising computer executable steps for transmitting said signal to said external controlled device.
